(19) United States
(12) Patent Application Publication
(10) Pub. No.: US 2026/0328332 A1
(43) Pub. Date: Oct. 22, 2026

(54) Friction Fit Holder for Smokeless Tobacco Cans

(71) Applicant: Braxton Fording, Chester, CA (US)

(72) Inventor: Braxton Fording, Chester, CA (US)

(21) Appl. No.: 19/468,838

(22) Filed: Feb. 3, 2026

(51) Int. Cl. F16M 11/04; A24F 23/00; B65D 25/20; F16M 11/22

(52) U.S. Cl. CPC F16M 11/041; B65D 25/20; F16M 11/22; A24F 23/00

(57) ABSTRACT

A friction-fit holder for retaining a container, such as a smokeless tobacco container, and associated methods are disclosed. The holder includes an open-top receiving cavity having a generally circular inner bottom surface area and a lateral circular lip extending upward from the inner bottom surface area. The lateral circular lip defines a lateral inner surface area configured to frictionally engage an outer surface of the container to retain the container within the receiving cavity while permitting insertion and removal. In certain embodiments, the lateral circular lip has a width at a base adjacent the inner bottom surface area that is greater than a width at a top of the lateral circular lip to facilitate insertion and secure retention.

### CROSS-REFERENCE TO RELATED APPLICATIONS

This application is a continuation-in-part of U.S. patent application Ser. No. 19/460,160, filed on Jan. 26, 2026, the entire disclosure of which is hereby incorporated by reference herein.

### FIELD OF DISCLOSURE

The present invention relates to portable storage devices and mounting accessories. More specifically, the invention concerns a friction-fit holder designed to retain smokeless tobacco cans and secure them to various surfaces using adhesive, magnetic, or removable mounting mechanisms.

### BACKGROUND

Smokeless tobacco products are commonly packaged in small cylindrical cans that users carry in pockets, vehicles, toolboxes, or place on desks and work surfaces. These cans frequently roll, fall, or become misplaced, and they can be difficult to access quickly. Existing storage solutions do not provide a compact, stable, and secure method for retaining a smokeless tobacco can in a fixed position while still allowing easy retrieval.

There is a need for a dedicated friction-fit holder that securely retains a smokeless tobacco can and attaches to a variety of surfaces for convenient access.

### SUMMARY OF THE INVENTION

The invention provides a friction-fit holder for smokeless tobacco cans. The holder includes an open-top receiving cavity sized to accept a smokeless tobacco can, with interior gripping surfaces that apply frictional force to the outer wall of the can. This friction-fit engagement allows the can to be inserted and removed manually while remaining securely retained during movement, vibration, or changes in orientation.

The holder includes a flat bottom surface that stabilizes the device when placed on horizontal surfaces. The holder attaches to surfaces using pressure-sensitive adhesive, magnetic mounting, or removable mounting options. The device may be manufactured in multiple internal diameters and lip-height configurations to accommodate different smokeless tobacco can formats.

### BRIEF DESCRIPTION OF THE DRAWINGS

FIG. 1 is a top perspective view of an embodiment of the friction-fit holder showing the layered structure of the receiving cavity.

FIG. 2 is a top plan view of the friction-fit holder illustrating the internal gripping surfaces and outer casing.

FIG. 3 is a bottom plan view of the friction-fit holder showing the mounting surface and attachment zones.

FIG. 4 is a side elevation view of the friction-fit holder showing the top surface, bottom surface, and lateral ends.

### DETAILED DESCRIPTION

### Reference numbers

Friction-fit holder 10
Receiving cavity 11
Inner bottom surface area 12
Lateral circular lip 13
Lateral inner surface area 14
Outer bottom surface area 15

The present disclosure relates to a friction-fit holder configured to retain and provide access to a smokeless tobacco container. While the embodiments described herein reference smokeless tobacco containers, the disclosed holder may be used with other containers having similar dimensions and form factors without departing from the scope of the disclosure.

Referring now to the drawings, like reference numerals designate like elements throughout the several views.

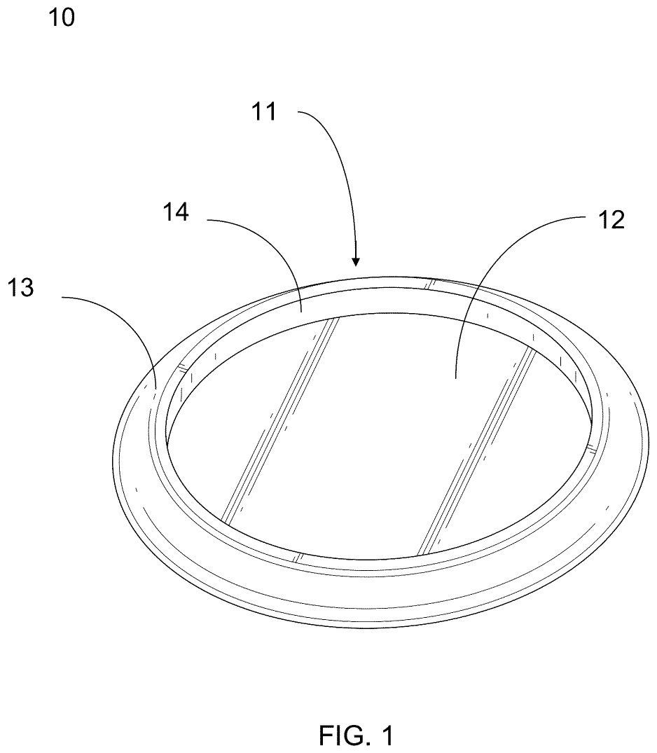

FIG. 1 is a top perspective view of an embodiment of a friction-fit holder (10) configured to retain a smokeless tobacco container. As shown in FIG. 1, the holder includes a receiving cavity (11) having an open top, an inner bottom surface area (12), and a lateral circular lip (13) extending upward from the inner bottom surface area (12). The lateral circular lip (13) defines a lateral inner surface area (14) configured to frictionally engage an outer surface of the smokeless tobacco container when the container is inserted into the receiving cavity (11).

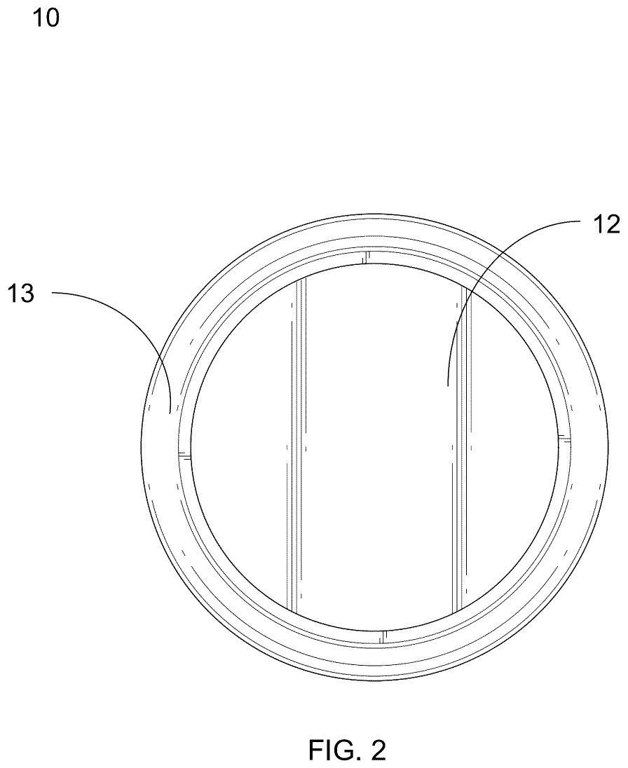

FIG. 2 is a top plan view of the friction-fit holder illustrating the generally circular geometry of the receiving cavity (11), the inner bottom surface area (12), and the lateral inner surface area (14) of the lateral circular lip (13). FIG. 2 further illustrates how the lateral circular lip (13) surrounds the receiving cavity (11) to provide circumferential frictional engagement with the container.

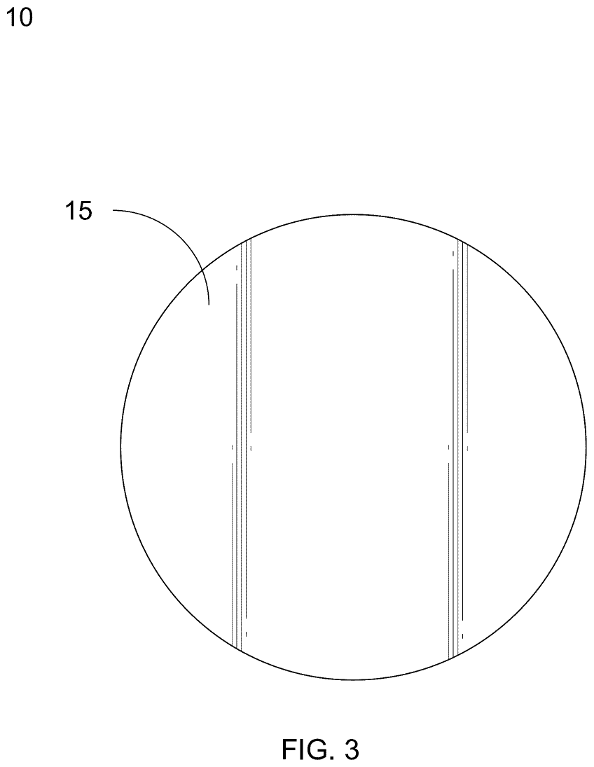

FIG. 3 is a bottom plan view of the friction-fit holder illustrating the outer bottom surface area (15). In some embodiments, the outer bottom surface area (15) may include or support an attachment mechanism, such as a pressure-sensitive adhesive or a magnetic mounting element, for securing the holder to a support surface.

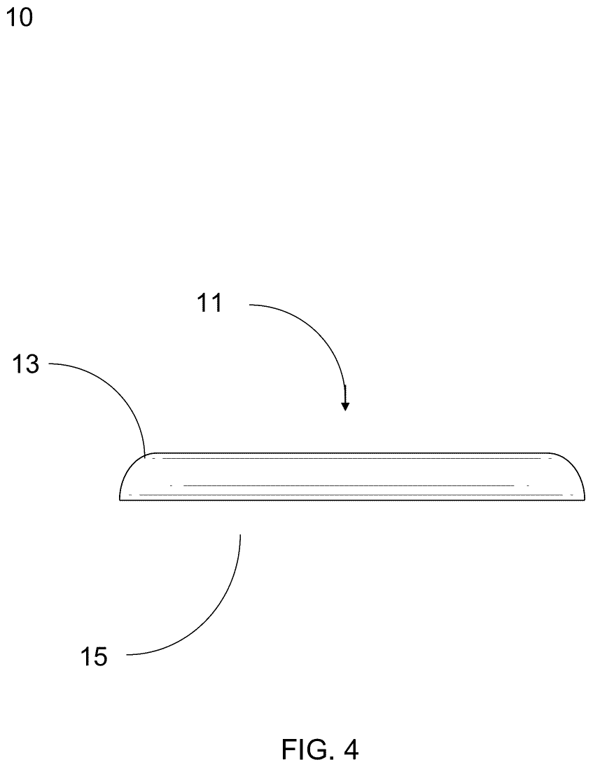

FIG. 4 is a side elevation view of the friction-fit holder showing the vertical relationship between the inner bottom surface area (12), the lateral circular lip (13), and the outer bottom surface area (15). As illustrated in FIG. 4, the lateral circular lip (13) extends upward from the inner bottom surface area (12) by a height sufficient to retain the container while allowing manual insertion and removal. In certain embodiments, FIG. 4 further illustrates a tapered configuration of the lateral circular lip (13), wherein a width of the lip near the inner bottom surface area (12) is greater than a width near a top edge of the lip.

Referring generally to the embodiments, a friction-fit holder includes a receiving cavity (11) configured to removably receive a smokeless tobacco container. The receiving cavity (11) is open at a top end to permit downward insertion of the container and Upward Removal of the Container by a User.

The receiving cavity (11) includes an inner bottom surface area (12) having a generally circular shape configured to support a bottom surface of the container. Extending upward from the inner bottom surface area (12) is a lateral circular lip (13). The lateral circular lip (13) defines a lateral inner surface area (14) configured to frictionally engage an outer circumferential surface of the container when the container is inserted into the receiving cavity (11).

An outer bottom surface area (15) may be provided opposite the inner bottom surface area (12). In some embodiments, the outer bottom surface area (15) is configured to rest on or attach to a support surface.

### Dimensions and Fit

In some embodiments, the receiving cavity (11) has an internal diameter sized to correspond to commercially available smokeless tobacco containers. In particular embodiments, the receiving cavity (11) has an internal diameter between about 64 millimeters and about 72 millimeters.

The lateral circular lip (13) extends upward from the inner bottom surface area (12) by a height sufficient to retain the container during normal use. In some embodiments, the height of the lateral circular lip (13), measured from the inner bottom surface area (12), is between about 4 millimeters and about 9 millimeters.

In some embodiments the lateral inner surface area (14) extends upward from the inner bottom surface area (12) by a height sufficient to retain the container during normal use. In some embodiments, the height of the lateral inner surface area (14), measured from the inner bottom surface area (12), is between about 4 millimeters and about 9 millimeters.

### Tapered Lip Geometry

In certain embodiments, the lateral circular lip (13) has a tapered geometry such that a width of the lateral circular lip (13) at a base adjacent the inner bottom surface area (12) is greater than a width of the lateral circular lip (13) at a top of the lip.

This tapered configuration provides multiple functional advantages. The reduced width at the top of the lateral circular lip (13) facilitates easier insertion of the container into the receiving cavity (11) by reducing insertion resistance at the entry point. As the container is pressed further downward, the increasing width toward the base causes increased frictional engagement between the lateral inner surface area (14) and the outer surface of the container, resulting in a more secure retention of the container near the inner bottom surface area (12).

In some embodiments, a maximum width of the lateral circular lip (13) near the base is greater than about 6.5 millimeters. In particular embodiments, the maximum width of the lateral circular lip (13) may be between about 6.5 millimeters and about 9.5 millimeters. Other embodiments may include widths greater than 6.5 millimeters depending on the desired retention force and container dimensions.

### Material Properties

In some embodiments, the lateral circular lip (13) is formed from a polymer material selected to provide elastic deformation and frictional retention. In particular embodiments, the polymer material comprises a thermoplastic polyurethane (TPU) having a Shore hardness of approximately 68 D.

In other embodiments, the polymer material may comprise a polymer blend or alternative elastomeric material having a Shore hardness substantially equivalent to the TPU material. For example, materials having a Shore A hardness in a range from approximately 85 A to approximately 95 A may be used to achieve similar frictional and elastic properties.

The selected polymer hardness allows the lateral circular lip (13) to elastically deform as the container is inserted, thereby accommodating dimensional tolerances of different containers while maintaining sufficient restoring force to frictionally retain the container. Upon removal of the container, the lateral circular lip (13) returns toward its original configuration.

### Textured Surfaces

In some embodiments, the lateral inner surface area (14) and the inner bottom surface area (12) include a texturized surface configured to increase frictional engagement with the container. The texturized surface may be formed by molding,

### Machining, or Additive Manufacturing Techniques.

In particular embodiments, the texturized surface comprises a grid-shaped pattern formed on one or both of the lateral inner surface area (14) and the inner bottom surface area (12). The grid-shaped pattern increases surface contact area and friction, thereby reducing slippage of the container during insertion, removal, or use.

In some embodiments, at least one of the inner bottom surface area or the lateral inner surface area includes a texturized surface comprising a plurality of parallel ridges configured to increase frictional engagement with the container.

In other embodiments, at least one of the inner bottom surface area or the lateral inner surface area comprises a surface substantially free of protrusions or recesses, such that the surface is generally smooth.

The texturized surfaces are especially beneficial in humid or wet environments, where smooth surfaces may otherwise allow reduced friction due to moisture, condensation, or residue on the container. The grid-shaped texture helps channel moisture away from contact points and maintain consistent frictional engagement.

### Attachment to Support Surfaces

In some embodiments, the holder further includes a pressure-sensitive adhesive configured to attach the holder to a support surface. The pressure-sensitive adhesive may be disposed on the outer bottom surface area (15) and allows the holder to be secured to surfaces such as dashboards, countertops, furniture, or interior vehicle panels.

In other embodiments, the holder includes a magnetic mounting element configured to attach the holder to a metal surface. The magnetic mounting element may be embedded within or coupled to the outer bottom surface area (15), allowing the holder to be removably attached to metal surfaces such as vehicle interiors, toolboxes, or appliances.

### Method of Use

A method of retaining and accessing a smokeless tobacco container includes positioning the friction-fit holder on a support surface, such as by adhesive attachment or magnetic attachment. The smokeless tobacco container is inserted downward into the open-top receiving cavity (11) such that the lateral inner surface area (14) of the lateral circular lip (13) frictionally engages the outer surface of the container.

As the container is inserted, the lateral circular lip (13) elastically deforms due to its polymer composition and tapered geometry. The container is retained within the receiving cavity by frictional engagement between the lateral circular lip (13) and the container. The container may be removed by applying an upward force sufficient to overcome the frictional engagement.

### Alternative Embodiments

While specific dimensions, materials, and textures have been described, it will be understood that variations may be made without departing from the scope of the claims. Different container sizes, polymer materials, surface textures, and attachment mechanisms may be employed depending on user preference and intended application.

In some embodiments, the circular inner bottom surface area has a diameter of about 65.4 millimeters, and the lateral circular lip extends upward from the inner bottom surface area to a top edge of the lateral circular lip by a total lip height of about 7 millimeters.

In other embodiments, the circular inner bottom surface area has a diameter of about 69.4 millimeters, and the lateral circular lip extends upward from the inner bottom surface area to a top edge of the lateral circular lip by a total lip height of about 6 millimeters.

Accordingly, the lip height and the height of the lateral inner surface area refer to the same vertical dimension extending upward from the inner bottom surface area.

As used herein, the term “about” accounts for normal manufacturing tolerances, material deformation during use, and dimensional variation among commercially available containers. In some embodiments, the stated diameters and lip heights may vary by ±0.5 millimeters, ±1.0 millimeter, or greater, without departing from the scope of the disclosure.

In further embodiments, the diameter of the inner bottom surface area and the height of the lateral circular lip may be selected in combination to achieve a desired frictional retention force for containers of different sizes, shapes, or materials. For example, a larger inner bottom surface diameter may be paired with a reduced lip height, while a smaller inner bottom surface diameter may be paired with an increased lip height, to provide substantially similar retention performance.

It will be understood that the specific dimensional pairings described herein are exemplary and non-limiting, and that other inner bottom surface diameters and corresponding lip heights may be used to accommodate variations in container geometry, material stiffness, user preference, or intended application.

### DEFINITIONS

“Friction-fit” means retention achieved through lateral compressive force without mechanical fasteners.

“Lip height” refers to the vertical height of the cavity wall that engages the can.

“Mounting surface” refers to any surface of the holder configured to receive an attachment mechanism.

Smokeless tobacco can” includes standard, slim, and oversized cylindrical containers used for smokeless tobacco products.

The figures and embodiments described herein are provided for illustrative Purposes Only and Are Not Intended to Limit the Scope of the Disclosure or the appended claims. The drawings are schematic in nature and are not necessarily drawn to scale, and certain features may be exaggerated, simplified, or omitted for clarity. The specific shapes, proportions, dimensions, surface textures, and relative arrangements of components shown represent example implementations, and other configurations capable of performing the same functions are contemplated. Any dimensions or dimensional ranges illustrated or described are exemplary unless expressly recited in the claims, and variations may be made without departing from the scope of the disclosure as defined by the claims.

What is claimed is:

1. A friction-fit holder for retaining a smokeless tobacco container, comprising:
an open-top receiving cavity sized to accept the container;
an inner bottom surface area having a generally circular shape; and
a lateral circular lip extending upward from the inner bottom surface area, wherein the lateral circular lip includes a lateral inner surface area configured to frictionally engage an outer surface of the container, and wherein the receiving cavity has an internal diameter between about 64 mm and about 72 mm, and the lateral circular lip has a height between about 4 mm and about 9 mm measured from the inner bottom surface area.

2. The friction-fit holder of claim 1, wherein the lateral circular lip has a width at a base adjacent the inner bottom surface area that is greater than a width at a top of the lateral circular lip.

3. The friction-fit holder of claim 2, wherein the lateral circular lip is formed from a polymer material having a Shore hardness selected to provide frictional retention of the container, the polymer material comprising a thermoplastic polyurethane having a Shore hardness of approximately 68 D, or a polymer blend having a Shore hardness substantially equivalent thereto, including polymer materials having a Shore A hardness of approximately 85 A to 95 A.

4. The friction-fit holder of claim 2, wherein the lateral inner surface area and the inner bottom surface area each include a texturized surface configured to increase frictional engagement with the container.

5. The friction-fit holder of claim 4, wherein the texturized surface comprises a grid-shaped pattern formed on the lateral inner surface area and the inner bottom surface area.

6. The friction-fit holder of claim 2, further comprising a pressure-sensitive adhesive configured to attach the holder to a support surface.

7. The friction-fit holder of claim 2, further comprising a magnetic mounting element configured to attach the holder to a metal surface.

8. The friction-fit holder of claim 2, wherein the lateral inner surface area and the inner bottom surface area are substantially free of protrusions or recesses.

9. A method of retaining and accessing a smokeless tobacco container, comprising:
positioning a friction-fit holder on a support surface, the holder including an open-top receiving cavity having a generally circular inner bottom surface area and a lateral circular lip extending upward from the inner bottom surface area;
inserting the smokeless tobacco container downward into the open-top receiving cavity such that an outer surface of the container is frictionally engaged by a lateral inner surface area of the lateral circular lip;
retaining the container within the receiving cavity by frictional engagement between the lateral circular lip and the outer surface of the container; and
removing the container from the receiving cavity by applying an upward force sufficient to overcome the frictional engagement.

10. The method of claim 9, wherein positioning the friction-fit holder on the support surface comprises attaching the holder to the support surface using a pressure-sensitive adhesive.

11. The method of claim 9, wherein positioning the friction-fit holder on the support surface comprises magnetically attaching the holder to a metal surface.

12. The method of claim 9, wherein inserting the container comprises elastically deforming the lateral circular lip formed from a polymer material having a Shore hardness selected to provide frictional retention.

13. The method of claim 9, wherein the frictional engagement is enhanced by a texturized surface formed on at least one of the lateral inner surface area or the inner bottom surface area of the receiving cavity.
